(19) United States
(12) Patent Application Publication
(10) Pub. No.: US 2002/0122813 A1
(43) Pub. Date: Sep. 5, 2002

(54) Insect attractants

(76) Inventor: Timothy Philip Healy, Wiltshire (GB)

Correspondence Address: FROMMER LAWRENCE & HAUG, 745 FIFTH AVENUE- 10TH FL., NEW YORK, NY, 10151, US

(21) Appl. No.: 10/125,902

(22) Filed: Apr. 19, 2002

Related U.S. Application Data
(63) Continuation-in-part of application No. PCT/GB00/04067, filed on Oct. 20, 2000.

(30) Foreign Application Priority Data
Oct. 21, 1999 (GB) 9924965.8

(51) Int. Cl. A01N 25/00

(52) U.S. Cl. 424/405

(57) ABSTRACT

A method of attracting an insect is described. The method uses a compound of the Formula (I): R—C(O)—X—COOH, wherein X is an optional linker group; wherein R is a suitable hydrocarbyl group; and wherein the compound of Formula (I) is capable of attracting said insect.

The present invention relates to a compound, and its use as an insect attractant, in particular a mosquito attractant.

In some cases, it is desirable to trap insects, especially those that act as carriers of harmful infectious agents.

Sometimes a trap is used. Typically the trap will comprise an insect attractant. An example of such an attractant is lactic acid. For example, see Geier and Boeckh (Entomologia Experimentalis et Applicata 1999: 92: 9-19) and Carlson et al (J Economic Entomology 1973: 329-31).

According to the present invention we have found that certain types of compounds are capable of attracting insects. Thus, the compounds may be used to divert insects away from animals, in particular humans.

Thus according to the present invention there is provided a method of attracting an insect comprising using a compound of the Formula I:

—C(O)—X—COOH (I)

wherein X is an optional linker group;

wherein R is a suitable hydrocarbyl group; and

wherein the compound of Formula I is capable of attracting said insect.

Typical examples of suitable linker groups X, if present, may include suitable hydrocarbyl groups, or other suitable groups such as —S—, —O —.

In this embodiment, preferably the group —C(O)—X—COOH acts as a bio-isostere of —C(O)COOH.

The term “bio-isostere” is used in its normal sense—namely a similar (but not the same) or a different chemical structure and having the same biological functional effect.

Without wishing to be bound by theory, we believe that the group —C(O)—X—COOH may bind to a receptor of the insect, as a result of which the insect is attracted to the compound.

In preferred compounds of the Formula 1, X is not present.

Thus, according to a preferred aspect, the compounds of the invention are of the general Formula (II)—viz.

R—C(O)—COOH (II)

wherein R is as defined above

As used herein, the term “hydrocarbyl group” means a group comprising at least C and H and may optionally comprise one or more other suitable substituents. Examples of such substituents may include halo-, alkoxy-, nitro-, an alkyl group, a cyclic group etc. In addition to the possibility of the substituents being a cyclic group, a combination of substituents may form a cyclic group. If the hydrocarbyl group comprises more than one C then those carbons need not necessarily be linked to each other. For example, at least two of the carbons may be linked via a suitable element or group (e.g. carbonyl). Thus, the hydrocarbyl group may contain hetero atoms. Suitable hetero atoms will be apparent to those skilled in the art and include, for instance, sulphur, nitrogen and oxygen.

Preferably, for group R, the hydrocarbyl group is any one or more of an alkyl group, an alkylene group, an alkenylene group, an alkenyl group, an alkynylene group, or an aryl group, including combinations thereof (e.g. an arylalkyl group)—which groups may optionally contain one or more heteroatoms or groups, and may further comprise substituents on the chain or rings.

According to a preferred aspect, the compounds of the invention are of the general Formula (III)—viz.

R1—C(O)—COOH (III)

wherein R1 is a hydrocarbon group.

Here the term “hydrocarbon” means any one of an alkyl group, an alkenyl group, an alkynyl group, which groups may be linear, branched or cyclic, or an aryl group, or combinations thereof (e.g. an arylalkyl group). The term hydrocarbon also includes those groups but wherein they have been optionally substituted. If the hydrocarbon is a branched structure having substituent(s) thereon, then the substitution may be on either the hydrocarbon backbone or on the branch; alternatively the substitutions may be on the hydrocarbon backbone and on the branch.

Preferably, R1 is an alkyl group.

Preferably, R1 is a linear alkyl group.

Thus, according to a preferred aspect, the compounds of the invention are of the general Formula (IV)—viz.

R2—C(O)—COOH (IV)

wherein R2 is a linear alkyl group.

Preferably R2 is a C1-C10 alkyl.

Preferably R2 is a C1-C6 alkyl.

More preferably, preferably R2 is a C1-C5 alkyl. More preferably, preferably R2 is C3 alkyl.

In a highly preferred aspect, the compound is 2-oxopentanoic acid.

By way of example only, alternative oxo-carboxylic acids that may be used in accordance with the present invention include oxopropanoic acid, oxobutanoic acid and 3-methyl-2-oxobutanoic acid.

For some applications, the —COOH group of the compounds of the present invention may be derivatised. However, those derivatives must also be capable of acting as an insect attractant. In some cases, the derivatives may be inactive forms of the compounds that on activation, such as heating, form into the active compounds.

In a highly preferred aspect, the —C(O)—X—COOH group does not undergo keto-enol tautomerism.

For some applications we have found that if the compound is airborne dispersed then its effectiveness is increased.

In order to achieve this desirable effect, preferably the compound is volatilised—i.e. it is in a volatilised state.

Preferred means for generating the volatilised compounds include heating, spraying etc. Heating may be achieved by electronic means.

The compound may be part of—such as contained in or on—an insect trapping device. Examples of such devices include sticky gum tapes, or netting or container traps. Container traps typically comprise a walled compartment for the retention of the attracted insects. In some cases, the trapping device may also include means for killing the insect —such as an insecticide or biopesticide. Alternatively, or in addition thereto, the trapping device may include means for sterilising or immobilising the insect.

Alternatively, the compound may be applied to any surface, such as walls, boards, or bait stations for example. In some cases, the surface may also include means for killing the insect—such as an insecticide or biopesticide. Alternatively, or in addition thereto, the surface may include means for sterilising or immobilising the insect.

In one aspect of the invention, the compound is contained within a container trap. This is desirable as it enables one to remove easily the attracted insects.

The compound of the present invention may be used to monitor insect populations, to control insect populations and/or to suppress insect populations. Thus, the compound may be used in conjunction with insect monitoring, control or suppression devices.

In a preferred aspect, the insect is a biting insect. More preferably, the insect is a flying, biting insect. Even more preferably, the insect is an anthropophilic insect.

In a more preferred aspect, the insect is a mosquito.

Preferably, the mosquito is of the genera Anopheles or Aedes.

In a highly preferred aspect, the mosquito is of the genus Anopheles.

In a more highly preferred aspect, the mosquito is Anopheles gambiae.

Anopheles gambiae s.s. is an important vector of malaria in Africa. The mosquito is considered highly anthropophilic¹.

The mosquito Anopheles gambiae, the type member of the An gambiae complex of six closely related major disease vectors, is a major vector of malaria. Malaria infects 500 million people per year, and kills 2 million people per year. The disease-causing organism transmitted by mosquitoes is the Plasmodium species.

Suitably, the mosquito may be of the genus Aedes.

Preferably, the mosquito is Aedes aegypti.

The mosquito Aedes aegypti is a non-specific mosquito, compared with An gambiae s.s., which is highly specific in biting humans. Ae aegypti is an important vector of malaria not only in Africa, but also in Asia and South America.

In a highly preferred aspect, when the mosquito is Aedes aegypti, the compound is volatilised. More particularly, when the mosquito is Aedes aegypti, the compound is preferably heated.

Thus, in summation, the present invention relates to the use of a compound of the Formula I:

R—C(O)—X—COOH (I)

as an insect attractant.

The compound may be used in combination with one or more other insect attractants By way of example only, other insect attractants that are suitable for use in combination with the compound of the present invention indude: carbon dioxide, 1octen-3-ol, ammonia and lactic acid. Preferably, the compound is mixed with one or more other insect attractants.

Suitably, the compound may be admixed with a suitable carrier, which may be a solvent such as water. Alternatively, or in addition thereto, the compound may be formulated with a suitable propellant. As a yet further alternative, the compound may be formulated in a controlled release material(s). Suitable slow release materials may include, by way of example only, cellulose materials, extruded or vacuum moulded polymers, hollow fibres, rubber, plastic membranes, wax, beads or microcapsules.

The present invention also encompasses an isolated compound as herein defined.

The present invention also encompasses an isolated, volatilised compound as herein defined.

The present invention also encompasses a trap comprising a compound of the present invention.

Some of the compounds of the present invention may be naturally occurring compounds that are secreted by animals—such as humans. Thus, by determining that these compounds act as attractants, so one is provided with a target to reduce their effectiveness as an insect attractant when they have been secreted In another aspect, it may even be possible to prevent their secretion.

Thus, the present invention also encompasses the use of the compound of the Formula I in an assay to screen for agents that mask or reduce the effectiveness of the compound as an insect attractant, when said compound is present on an animal surface (such as human skin).

The present invention also encompasses an agent identified by said screen. The agent may be admixed with a suitable carrier, diluent or excipient. The agent may be for topical use. The agent may be a cream or an aerosol formulation. The agent may be mixed with one or more other insect repellents The agent may be mixed with other active compounds—such as a UV blocking agent.

The present invention will now be described only by way of example, in which reference will be made to the following Figures:

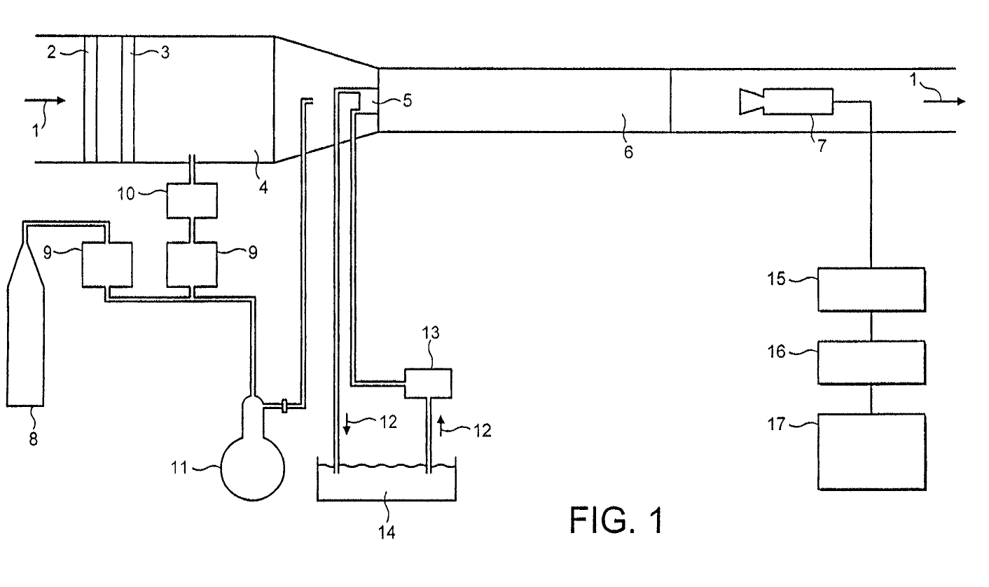

FIG. 1 is a schematic diagram;

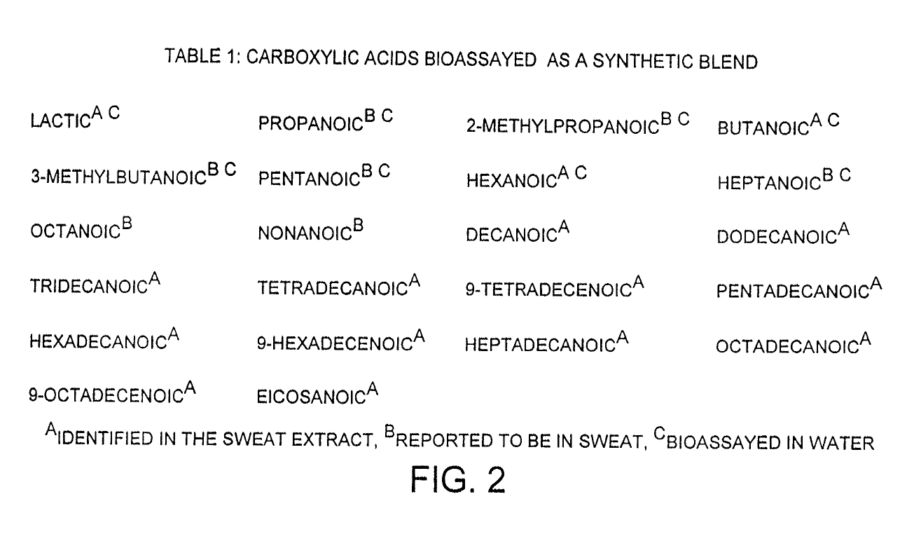

FIG. 2 is a table;

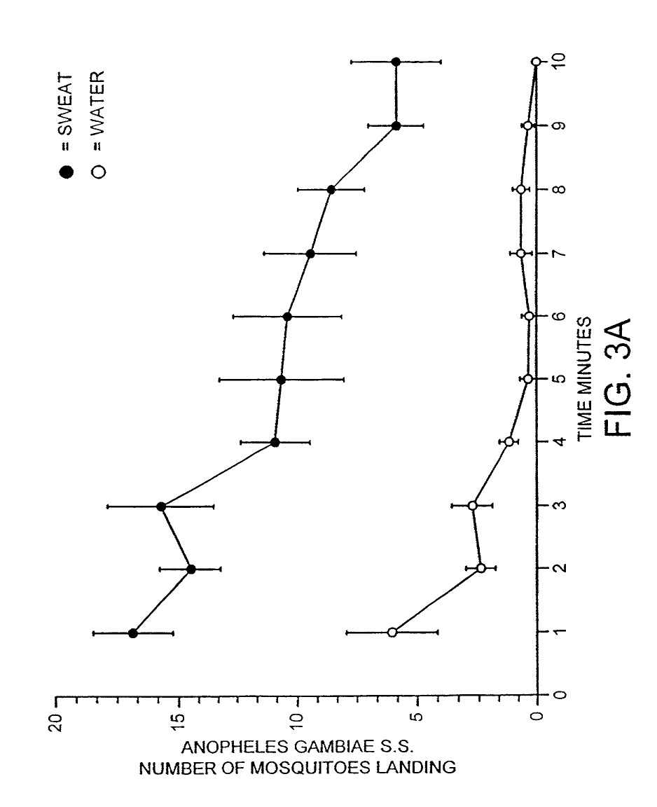

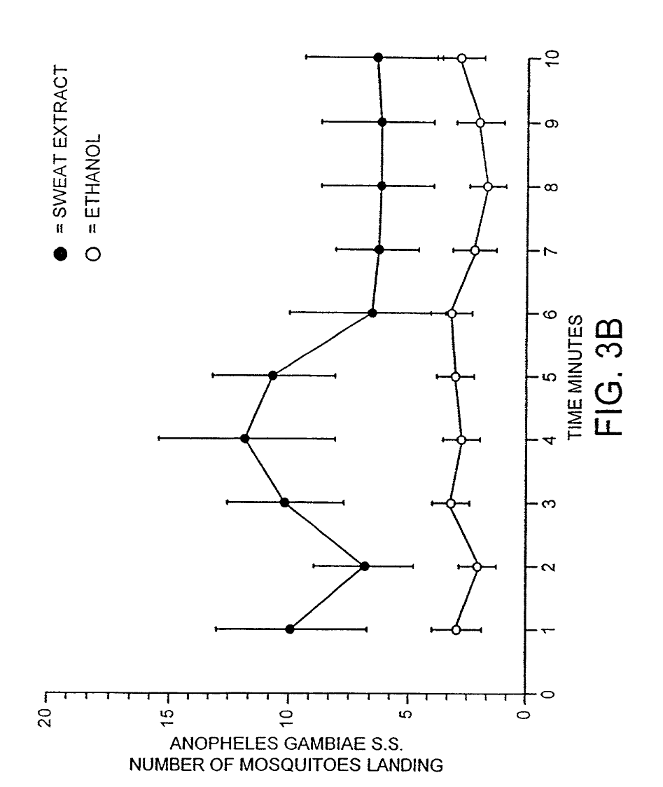

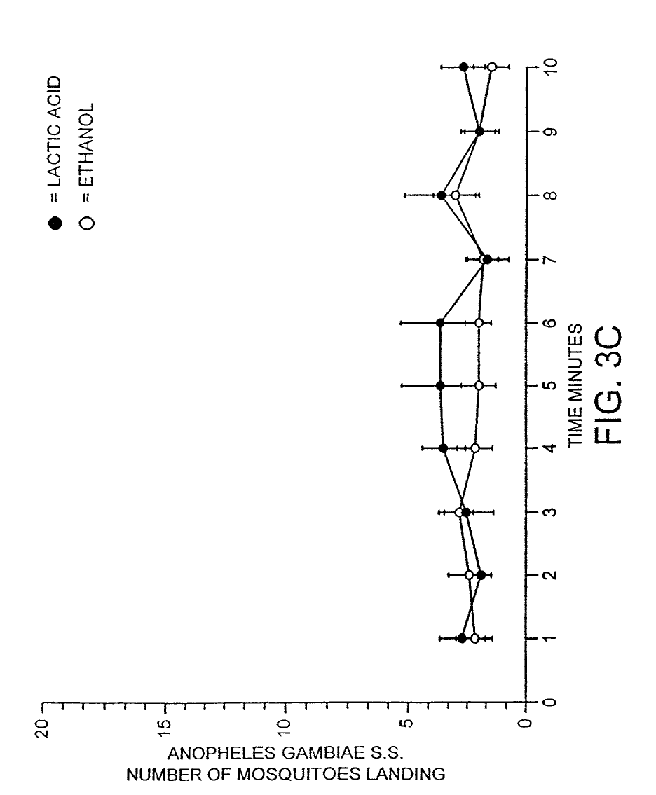

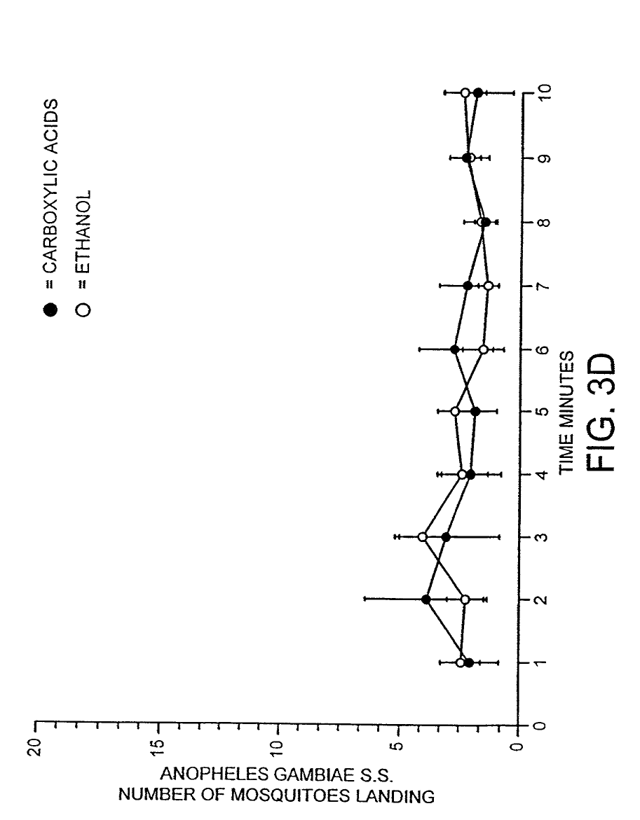

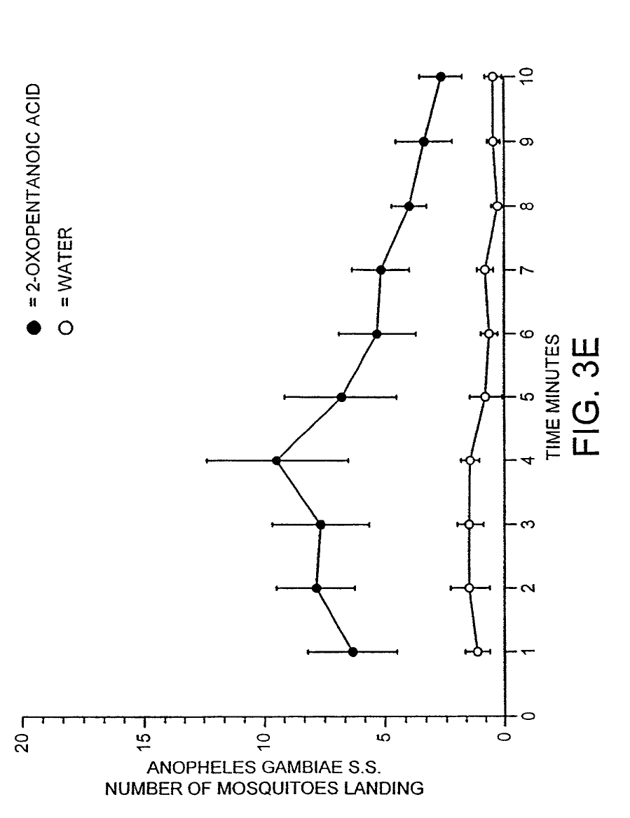

FIG. 3 presents a series of graphs in respect of Anopheles gambiae;

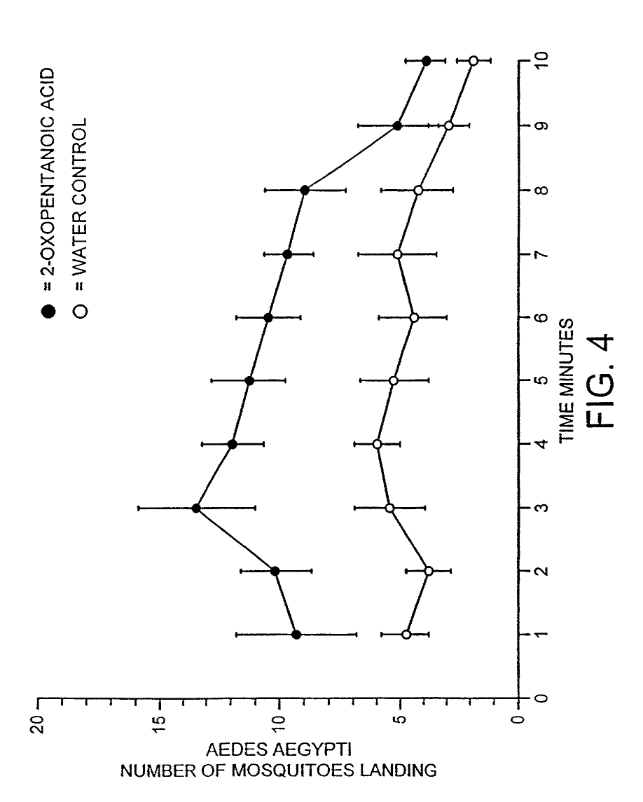

FIG. 4 presents a graph in respect of Aedes aegypti; and

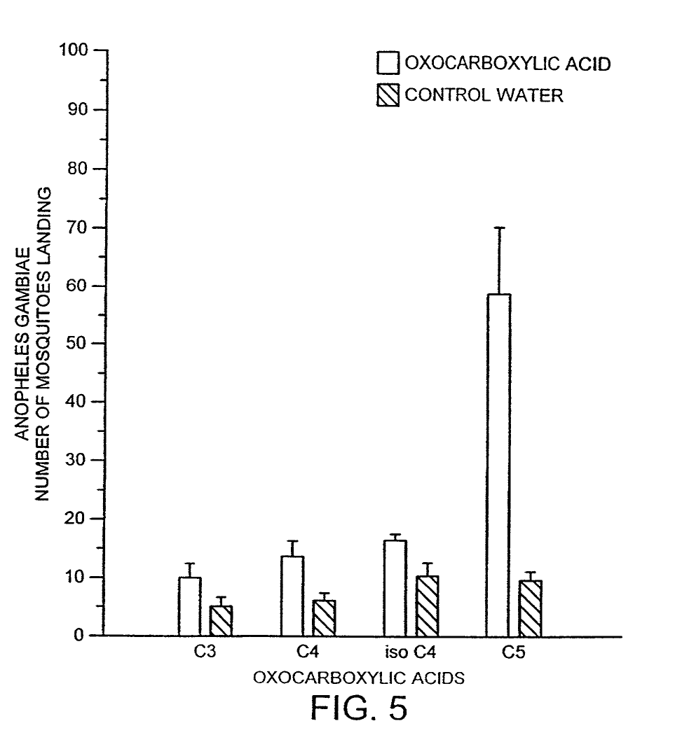

FIG. 5 presents a graph in respect of the activity of a series of αoxo-carboxylic acids

In more detail:

FIG. 1 is a schematic diagram of wind tunnel and bioassay equipment

In this respect, 1 denotes air flow, 2 denotes activated charcoal filter, 3 denotes a molecular sieve filter, 4 denotes stainless steel mesh, 5 denotes a heated glass cylinder, 6 denotes a flight chamber, 7 denotes a video camera, 8 denotes a carbon dioxide cylinder, 9 denotes a flow meter, 10 denotes an air pump, 11 denotes a balloon and wash bottle head, 12 denotes water flow, 13 denotes a water pump, 14 denotes a water bath, 15 denotes a video splitter, 16 denotes a video recorder, 17 denotes a monitor.

FIG. 3 presents bioassay results. Mean number of Anopheles gambiae mosquitoes landing on filter papers. (6 replicates, ± standard error of means) A, sweat and water. B, sweat extract and ethanol. C, lactic acid and ethanol. D, carboxylic acids and ethanol. E, 2-oxopentanoic acid and water.

FIG. 4 presents a bioassay result in respect of Aedes aegypti. Mean number of Aedes aegypti mosquitoes landing on filter papers. (6 replicates, ± standard error of means), 2-oxopentanoic acid and water.

FIG. 5 presents the results of a comparative bioassay of a number of oxo-carboxylic acids, namely oxopropanoic acid (C3), oxobutanoic acid (C4), 3-methyl,2-oxobutanoic acid (iso-C4) and 2-oxopentanoic acid (C5), wherein the control is water. Mean number of Anopheles gambiae mosquitoes landing on filter papers. (6 replicates, ± standard error of means).

### EXPERIMENTAL

Methods

Mosquitoes

Trials used either Aedes aegypti or the Tanzanian KWA strain of Anopheles gambiae s.s., both obtained from the London School of Hygiene and Tropical Medicine. The rearing and bioassay rooms were maintained at 27° C. ±2° and 70% RH ±10%. The rearing room was kept on a 12/12 light dark cycle of 170 Wm⁻² and 0.3 Wm⁻² respectively with a 30 minute dusk period of 0.5 Wm⁻² at the day night interface.

Determination of Lactic Acid

Due to the high polarity of lactic acid a specialised packing of a deactivated graphitised carbon black support (80/120 Carbopack B-DA) coated with Carbowax 20 M was used in 2 mm×1.5 m glass column¹⁴. Prior to injecting a sample the column was conditioned with 7 injections of 0.03 M oxalic acid in water. Two ml of distilled water were added to 2 ml of the ether extract and the mixture was shaken for 30 min. The ether was evaporated off under nitrogen and 3 μl of the remaining water were injected into the ‘Carbopack’ column installed in a Pye Unicam 4500 GC. Operating conditions: injector, 250° C.; temperature programme, isothennal 200° C.; carrier gas, nitrogen 24 ml min⁻¹ detector, FID, 250° C. A calibration curve was constructed with range of concentrations of L-(+)-lactic acid, purity>98%.

Chemical Analysis

Analysis was undertaken in the original ether to avoid possible esterification of any carboxylic acids by ethanol in the heated injector of the GC. A WCOT fused silica capillary column (25 m×0.32 mm i.d.) coated with CP-WAX-58 (FFAP) film thickness 0.2 mm, was used in a Hewlett Packard 5890 GC, operating conditions: injector, split/splitless, 50:1 split, 250° C.; temperature programme, 3° C. min⁻¹ from 70° C.-250° C.; carrier gas, helium at 250 kPa. The GC was interfaced with a Finnigan magnum ion trap detector using electron impact ionisation, mass range 36-399, source temperature 250° C. The same column was fitted to a 3400 Varian GC and used to compare standard compounds with peaks identified in the extract. Operating conditions: injector split/splitless, 50:1 split, 250° C.; temperature programme, 15° C. min⁻¹ from 70° C.-250° C. and 6 min at 250° C.; carrier gas, nitrogen at 1.4 ml min⁻¹; detector, FID, 250° C.

### DISCUSSION

The odour plume emanating from a human contains a complex mixture of volatile organic compounds that evaporate from the skin surface or are exhaled in breath. Analysis of the total body effluvia of encapsulated individual humans has revealed the presence of over 300 compounds⁷. Exhaled human breath has been reported to contain at least 102 organic compounds⁸. Of the compounds within a human odour plume, carbon dioxide is known to activate An gambiae s.s. into upwind flight⁹ and is considered to act as a kairomone for host seeking mosquitoes during upwind flight^{10,11}. Recent African field studies using odour-baited entrance traps in huts demonstrated that a human bait caught more An gambiae s.l. than an equivalent amount of carbon dioxide¹². When two traps were used, one containing a human and one containing a calf, a much higher percentage of An gambiae s.s. were caught in the human trap¹³. Human sweat has been reported to attract An gambiae s.s.¹⁴.

The development of a behaviourally discriminating bioassay that can accurately determine the olfactory stimuli in an odour plume that elicit behavioural responses in a small nocturnal mosquito that demonstrates variable 3-dimensional flight patterns represents a considerable technological challenge. To circumvent this problem we concentrated on investigating the landing responses of An gambiae s.s. on heated glass cylinders treated with sweat and sweat extracts. The bioassay was conducted in a wind tunnel⁹ that was connected to 2 identical flight chambers, stainless steel frames 1.0 m long, covered in thin gauge plastic tubing and sealed at both ends with mosquito netting, FIG. 1. Twenty, 5-8 day old An gambiae s.s. females were introduced into each flight chamber. The mosquitoes were activated with 2 pulses of carbon dioxide, diluted with filtered air to give pulses of 0.1% above background. Activated mosquitoes flew upwind and approached heated (34° C., human skin temperature) glass cylinders to which strips of filter paper were attached. The number of mosquitoes landing per minute on each filter paper was recorded for 10 min by infra-red sensitive video cameras situated downwind of the flight chambers. All bioassays began on the 3rd hour of the night period (21.00 h).

To collect sweat, strips of filter paper were strapped around the leg, just above the ankle, of a human volunteer for 24 h. A strip of sweat impregnated filter paper was placed onto one cylinder and a filter paper dampened with 30 pl of distilled water was placed onto the second, the control, cylinder The bioassay was repeated 6 times, the position of the sweat and the control filter papers alternated between bioassays. The response to the warmed sweat was highly significant. The total number of landings (TNL) that occurred on the sweat filter paper was 649 in comparison to the water control (TNL=87), ANOVA for mosquitoes landing per min on sweat and control (F_{1,113}=152.93, P<0.001). The response to the sweat declined during the bioassay, FIG. 3A, and is probably due to the evaporation of behaviourally active volatiles.

Sweat extracts were made by solvent extraction, with diethyl ether, of 50 strips of sweat impregnated filter paper that had been stored in ether at 4° C. The ether was slowly evaporated under filtered nitrogen to 5 ml. Diethyl ether is an insect anaesthetic and was replaced with ethanol for the bioassay. Two ml of ethanol was added to 2 ml of extract and the mixture was shaken for 30 min, the ether was then evaporated off. The extraction procedure was repeated with clean filter papers and the resulting ethanol was used as the control. Thirty μl of extract and solvent control were bioassayed. Significantly more landings occurred on the filter paper treated with the sweat extract (TNL=491) in comparison to the ethanol control (TNL=153) (F_{1,113}=63.39; P<0.01), FIG. 3B. The effect of ethanol was examined. There was not a significant difference between the ethanol (TNL=141) and a blank control (TNL=104)(F_{1,113}=3.64; P>0.05). The response to the extract is different when compared to sweat. Instead of a steady decline, the response reaches a small peak of activity at the 4th minute. An excess of solvent may be affecting the response during the initial 3 minutes.

L(+) lactic acid (2-hydroxypropanoic) has been isolated from human sweat and reported as an attractant for Ae aegypti⁴⁻⁶. The concentration of lactic acid in the sweat extract was estimated by Gas Liquid Chromatography¹⁵ to be 0.21 μg/μl. The landing response of An gambiae s.s mosquitoes to lactic acid was evaluated using the bioassay as detailed above. Bioassays of lactic acid in ethanol at 0.2 μg/μl did not elicit significant levels of landings (TNL=167), ethanol control (TNL=131) (F^{1,113}=2.99; P>0.05), FIG. 3C.

Chemical analysis of the extract (Table 1, FIG. 2) revealed the presence of 73 compounds of which 40 were tentatively identified. The major peaks in the extract were a series of aliphatic carboxylic acids, C3-C20. The acids varied in concentration from hexadecanoic, 5.4 μg/μl to tridecanoic 0.1 μg/μl. The extraction procedure and chemical analysis did not detect some of the lower molecular weight acids and their methyl branched isomers (iso acids) that have been reported in other analyses of sweat^{16,17}. A similar series of carboxylic acids has been reported to attract An gambiae s.s.¹⁸ and electrophysiological responses to the C3-C8 acids have been recorded from the antennae of An gambiae s.s.¹⁷⁻¹⁹. However when a blend of all of the acids identified in the extract and the acids reported in the other studies was bioassayed using An gambiae, all at 1 μg/μl in ethanol, (TNL=139) they did not elicit significant levels of landings compared to an ethanol control (TNL=135) (F_{1,113}=0.03; P>0.05), FIG. 3D. The water soluble carboxylic acids, ≦C7, were bioassayed in water, all at 1 μg/μl, to see if there was an interactive effect with water vapour which has been previously reported²⁰. However the acids still did not elicit significant levels of An gambiae landings (TNL=143) in comparison to a water control (TNL=179) (F_{1,113}=2.14; P>0.05). The previous studies recorded responses of flying An gambiae s.s. at much lower concentrations of carboxylic acids. It is possible that different stimuli may be involved in flying and landing behaviour

The lack of response by An gambiae s.s. to lactic acid and the aliphatic carboxylic acids still left the identity of the compound or compounds in the extract that did elicit the landing response to be resolved. The difficulties experienced in determining the concentration of lactic acid in the extract by GLC emphasised the possibility that highly polar substituted carboxylic adds could be present in the extract but would not be detected by GLC due to adsorption in the injector or on the column. Several hydroxy and oxo substituted carboxylic acids are known to occur in human blood and urine²¹. Studies of the levels of these adds routinely resort to derivatisation, typically to TriMethlySilyl esters or to TMS-oximes for the oxo-acids, to achieve reproducible results²¹. Derivatization will however result in the restriction (and sometimes loss) of biological activity. Prior to initiating a derivatized analysis of a sweat extract it was decided to bioassay some of the substituted acids. A solution of 2-oxopentanoic acid (α-ketovaleric), purity>97%, in water at 1 μg/μl did elicit significant levels of landings (TNL=352) of An gambiae s.s. in comparison to a water control (TNL=56) (F_{1,113}=80.67; P<0.001), FIG. 3E. The response to the acid is also observed to peak at 4 minutes. The discovery that 2-oxopentanoic acid does elicit a landing response in An gambiae s.s. suggests that further research to determine the presence, identity, concentration and behavioural activity of oxo-carboxylic acids in sweat is required Previous studies of the oxo-carboxylic acids in human fluids usually report the presence of the branched chain (iso) acids. 4-methyl-2-oxopentanoic acid is reported in blood²² and 3-methyl-2-oxobutanoic, 4-methyl-2-oxopentanoic and 3-methyl-2-oxopentanoic are found in urine . These iso-oxo carboxylic acids are the metabolic precursors, via a reversible transamination, of the amino acids valine, leucine and isoleucine respectively. The iso-oxo carboxylic acids are however considered to be unstable and are usually stored as sodium salts and require acidification to release the free acid.

The bioassay detailed above was also used to evaluate the landing response of Ae aegypti to a solution of 2-oxopentanoic acid (α-ketovaleric), purity>97%, in water at 1 μg/μl. The An gambiae s.s. females in the bioassay were thus replaced with Ae aegypti females. The 2-oxopentanoic acid solution elicited significant levels of landings of Ae aegypti (FIG. 4).

A study investigating the structural activity relationship of analogues of lactic acid with Ae aegypti found that several substituted carboxylic acids, including 2-oxopentanoic, were as attractive as lactic acid²⁴.

The landing response of An gambiae and Ae aegypti suggests that oxo-carboxylic acids may make an important contribution to the efficacy of mosquito traps designed to monitor field populations of either An gambiae s.s. or Ae aegypti. In the bioassay the video cameras are focused onto the surface of the filter papers and do not indicate whether arrestment or orientated attraction over a distance is occurring. For orientated attraction volatilisation of the stimulus into the air is required 2-xopentanoic acid has a comparatively low molecular weight, MW 116. However highly polar organic acids often demonstrate low volatility due to intermolecular hydrogen bonding. Human body temperature and the evaporation of water from the skin surface may result in the acids volatilising from a human. This implies that temperature and evaporation rates will be critical for successful trapping.

In order to evaluate the activity of other α-oxo-carboxylic acids, the above detailed bioassay was repeated with An gambiae and each of the following compounds: oxopropanoic acid (C3), oxobutanoic acid (G4), 3-methyl,2-oxobutanoic acid (iso-C4) and 2-oxopentanoic acid (C5). The control used was water. Although the greatest response was seen with 2-oxopentanoic acid, the other compounds (particularly C4 and iso-C4) did elicit significant levels of landings as compared to the water control (FIG. 5).

### SUMMARY

Anopheles gambiae s.s. is an important vector of malaria in Africa. The mosquito is considered highly anthropophilic¹. Host location by An gambiae s.s. is considered to involve as yet unidentified olfactory stimuli contained within the odour plume associated with a human^{2,3}. To investigate the role of sweat volatiles we used a wind tunnel bioassay to observe landing responses of An gambiae s.s. on heated glass cylinders. Filter papers impregnated with human sweat elicited significant levels of landings as did an ether extract of the filter papers. The concentration of lactic acid, a reported mosquito attractant⁴⁻⁶, in the extract was determined but bioassays of an equivalent concentration of lactic acid did not elicit significant levels of landings. Chemical analysis of the extract indicated that the major components were aliphatic carboxylic acids. A synthetic blend of 22 carboxylic (see FIG. 2) acids did not elicit significant levels of landings. Bioassays of 2-oxopentanoic acid did elicit significant levels of landings. This response suggests that oxo-carboxylic acids are involved in host location and may have a potential use as odour baits for mosquito traps.

Aedes aegypti is a further important vector of malaria not only in Africa, but also in Asia and South America. To investigate the role of 2-oxopentanoic acid we used a wind tunnel bioassay to observe landing responses of Ae aegypti on heated glass cylinders. Bioassays of 2-oxopentanoic acid did elicit significant levels of landings. This response suggests that oxo-carboxylic acids are involved in host location not only of An gambiae but also of Ae aegypti.

Oxo-carboxylic acids, other than 2-oxopentanoic acid, also elicited significant levels of landings when bioassayed with An gambiae. This response suggests that a number of oxo-carboxylic acids may have a potential use as odour baits for mosquito traps.

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry, biology or related fields are intended to be within the scope of the following claims.

### REFERENCES

1. White, G. B. Anopheles gambiae complex and disease transmission in Africa. Trans. R. Soc. trop. Med. Hyg. 68, 278-301 (1974).

2. Gibson, G. & Torr, S. J. Visual and olfactory responses of haematophagous Diptera to host stimuli. Med. Vet. Entomol. 13, 2-23 (1999).

3. Takken, W. & Knols, B. G. J. Odor-mediated behaviour of afrotropical malaria mosquitoes. A. Rev. Ent. 44, 131-157 (1999).

4. Acree, F., Turner, R. B., Gouck, H. K., Beroza, M. & Smith, N. L-Lactic acid:a mosquito attractant isolated from humans. Science 161, 1346-1347 (1968).

5. Smith, C. N., Smith, N., Gouck, H. K., Weidhass, D. E., Gilbert, I. H., Mayer, M. S., Smittle, B. J. & Hofbauer, A. L-Lactic acid as a factor in the attraction of Aedes aegypti (Diptera: Culicidae) to human hosts. Ann. ent. Soc. Am. 63, 760-770 (1970).

6. Eiras, A. E. & Jepson, P. C. Host location by Aedes aegypti (Diptera: Culicidae): a wind tunnel study of chemical cues. Bull. ent Res. 81, 151-160 (1991).

7. Ellin, R. I., Farrand, R. L., Oberst, F. W., Crouse, C. L, Billups, N. P., Koon, W. S., Musselman, N. P. & Sidell, F. R. An apparatus for the detection and quantitation of volatile human effluents. J. Chromat 100, 137-152(1974).

8. Krotoszynski, B., Gabriel, G. & O'Neill, H. Characterization of human expired air: a promising investigative and diagnostic technique. J. Chromatogr. Sci. 15, 239-244 (1977).

9. Healy, T. P. & Copland, M. J. W. Activation of Anopheles gambiae mosquitoes by carbon dioxide and human breath. Med. Vet Entomol. 9, 331-336 (1995).

10. Gillies, M. T. The role of carbon dioxide in host-finding by mosquitoes (Diptera:Culicidae): a review. Bull ent Res. 70, 525-532 (1980).

11. Takken, W. The role of olfaction in host-seeking mosquitoes: a review. Insect Sci. Applic. 12, 287-295 (1991).

12. Constantini, C., Gibson, G., Sagon, N. F., Della Torre, A., Brady, J. & Coluzzi, M. Mosquito responses to carbon dioxide in a West African Sudan savanna village. Med. Vet. Entomol. 10, 220-227 (1996).

13. Constantini, C., Sagon, N. F., Della Torre, A., Diallo, M., Brady, J., Gibson, G. & Coluzzi, M. Odor-mediated host preferences of West African mosquitoes with particular reference to malaria vectors. Am. J. trop. Med. Hyg. 58, 56-63 (1998).

14. Braks, M. A. H. & Takken, W. Incubated human sweat but not fresh sweat attracts the malaria mosquito Anopheles gambiae sensu stricto. J. Chem. Ecol. 25, 663-672 (1999).

15. Fussell, R. J. & McCalley, D. V. Determination of volatile fatty acids (C2-C5) and lactic acid in silage by gas chromatography. Analyst 112, 1213-1216 (1987).

16. Perry, T. L., Hansen, S., Diamond, S., Bullis, B., Mok, C. & Melancon, S. B. Volatile fatty acids in normal human physiological fluids. Clinica chim. Acta 29, 369-374 (1970).

17. Cork, A. & Park, K. C. Identification of electrophysiologically-active compounds for the malaria mosquito, Anopheles gambiae, in human sweat extracts. Med. Vet. Entomol. 10, 269-276 (1996).

18. Knols, B. G. J., van Loon, J. J. A., Cork, A., Robinson, R. D., Adam, W., Meijerink, J., De Jong, R. & Takken, W. Behavioural and electrophysiological responses of the female malaria mosquito Anopheles gambiae (Diptera: Culicidae) to Limburger cheese volatiles. Bull ent. Res. 87, 151-159 (1997).

19. Meijerink, J. & van Loon, J. J. A. Sensitivities of antennal olfactory neurons of the malaria mosquito, Anopheles gambiae, to carboxylic acids. J. Insect. Physiol. 45, 365-373 (1999).

20. Takken, W., Knols, B. G. J. & Otten, H. Interactions between physical and olfactory cues in the host-seeking behaviour of mosquitoes: the role of relative humidity. Ann. trop. Med. Parasit. 91, Supplement No. 1 S119-S120 (1997).

21. Chalmers, R. A. & Lawson, A. M. Organic acids in man (Chapman and Hall. London. 1982).

22. Hagenfeldt, L. Gas chromatographic determination of organic acids in blood. Ark. Kemi 29, 63-73 (1968).

23. Hoffman, N. E., Gooding, K. M., Sheahan, K. M. & Tylenda, C. A. Gas chromatographic determination of urinary aliphatic α-keto acids. Res. Comm. Chem. Pathol. Pharmacol. 2, 87-94 (1971).

24. Carlson, D. A., Smith, N. Gouck, H. K. & Godwin, D. R. Yellowfever mosquitoes: Compounds related to Lactic acid that attract females. J. econ. Ent. 66, 329-331 (1973).

The invention will now be further described by the following numbered paragraphs:

1. A method of attracting an insect comprising using a compound of the Formula I:

R—C(O)—X—COOH (I)

wherein X is an optional linker group;

wherein R is a suitable hydrocarbyl group; and

wherein the compound of Formula I is capable of attracting said insect.

2. A method according to paragraph 1 wherein the compound has the Formula III:

R1—C(O)—COON (III)

wherein R1 is a suitable hycrocarbon group.

3. A method according to paragraph 1 or paragraph 2 wherein R or R1 is an alkyl group.

4. A method according to paragraph 3 wherein R or R1 is a C1-C10 alkyl.

5. A method according to paragraph 4 wherein R or R1 is a C1-C6 alkyl.

6. A method according to paragraph 5 wherein R or R1 is a C1-C5 alkyl.

7. A method according to paragraph 6 wherein R or R1 is a C3 alkyl.

8. A method according any one of the preceding paragraphs wherein said compound is 2-oxopentanoic acid.

9. A method according to any one of the preceding paragraphs wherein said insect is a mosquito, preferably of the genus Anopheles.

10. A method according to any one of the preceding paragraphs wherein sa id insect is Anopheles gambiae.

11. A method according to any one of the preceding paragraphs wherein said compound is in a volatilised state.

12. A method according to paragraph 11 wherein said compound is volatilised by heating said compound.

13. A method according to paragraph 11 wherein said compound is volatilised by spraying said compound.

14. A method according to any one of paragraphs 1-8 wherein said insect is a mosquito of the genus Aedes and wherein said compound is in a volatilised state.

15. A method according to any one of paragraphs 1-8 wherein said insect is Aedes aegypti and wherein said compound is in a volatilised state.

16. A method according to paragraph 14 or paragraph 15 wherein said compound is volatilised by heating said compound.

17. A method according to paragraph 14 or paragraph 15 wherein said compound is volatilised by spraying said compound.

18. A method according to any one of the preceding paragraphs wherein said compound is contained in or on an insect trapping device.

19. A method according to paragraph 18 wherein said trapping device is a container trap.

20. A method according to any one of the preceding paragraphs wherein said compound is used in combination with one or more other insect attractants.

21. A method according to paragraph 20 wherein said other insect attractants are selected from the group consisting of carbon dioxide, 1-octen-3-ol and lactic acid.

22. A method according to any one of the preceding paragraphs wherein said compound is derivatised and wherein the derivative is capable of acting as an insect attractant.

23. A method according to any one of the preceding paragraphs wherein said compound is formed from an inactive derivative upon activation thereof.

24. An isolated compound as defined in any one of the preceding paragraphs.

25. A trap comprising a compound as defined in any one of the preceding paragraphs.

26. Use of a compound as defined in any one of the preceding paragraphs in an assay to screen for agents that mask or reduce the effectiveness of the compound as an insect attractant, when said compound is present on an animal surface.

27. An agent identified in the assay according to paragraph 24.

28. A method of attracting an insect comprising using isolated 2-oxopentanoic acid; and wherein said 2-oxopentanoic acid is in a volatilised state.

29. A method of attracting an insect comprising using a combination consisting of 2-oxopentanoic acid and carbon dioxide; and wherein said 2-oxopentanoic acid is in a volatilised state.

30. A method of attracting an insect comprising using a combination consisting of 2-oxopentanoic acid and lactic acid; and wherein said 2-oxopentanoic acid is in a volatilised state.

31. A method of attracting an insect comprising using 2-oxopentanoic acid but wherein said 2-oxopentanoic acid is not used in combination with a compound as shown as formula I in W000165910; and wherein said 2-oxopentanoic acid is in a volatilised state.

32. A method according to any one of the preceding paragraphs wherein said insect is a mosquito, preferably of the genus Anopheles.

33. A method according to any one of the preceding paragraphs wherein said insect is Anopheles gamblae.

34. A method according to any one of the preceding paragraphs wherein said compound is volatilised by heating said compound.

35. A method according to any one of the preceding paragraphs wherein said compound is volatilised by spraying said compound.

36. A method according to any one of the preceding paragraphs wherein said compound is contained in or on an insect trapping device.

37. A method according to paragraph 36 wherein said trapping device is a container trap.

38. A method of attracting an insect comprising using isolated 2-oxopentanoic acid; and wherein said insect is of the genus Anopheles.

39. A method of attracting an insect comprising using a combination consisting of 2-oxopentanoic acid and carbon dioxide; and wherein said insect is of the genus Anopheles.

40. A method of attracting an insect comprising using a combination consisting of 2-oxopentanoic acid and lactic acid; and wherein said insect is of the genus Anopheles.

41. A method of attracting an insect comprising using 2-oxopentanoic acid but wherein said 2-oxopentanoic acid is not used in combination with a compound as shown as formula I in W400/65910; and wherein said insect is of the genus Anopheles.

42. A method according to any one of paragraphs 38-41 wherein said insect is Anopheles gambiae.

43. A method according to any one of paragraphs 38-42 wherein said compound is in a volatilised state.

44. A method according to any one of paragraphs 38-43 wherein said compound is volatili sed by heating said compound.

45. A method according to any one of paragraphs 38-44 wherein said compound is volatilised by spraying said compound.

46. A method according to any one of paragraphs 38-45 wherein said compound is contained in or on an insect trapping device.

47. A method according to paragraph 46 wherein said trapping device is a container trap.

48. Use of a compound of the Formula I:

R—C(O)—X—COOH (I)

wherein X is an optional linker group;

wherein R is a suitable hydrocarbyl group; and in an assay to screen for agents that mask or reduce the effectiveness of the compound as an insect attractant, when said compound is present on an animal surface.

1. A method of attracting an insect comprising using isolated 2-oxopentanoic acid; and wherein said 2-oxopentanoic acid is in a volatilised state.

2. The method of claim 1, further comprising using 2-oxopentanoic acid in combination with carbon dioxide.

3. The method of claim 1, further comprising using 2-oxopentanoic acid in combination with lactic acid.

4. A method of attracting an insect comprising using 2-oxopentanoic acid but wherein said 2-oxopentanoic acid is not used in combination with a compound as shown as formula I: 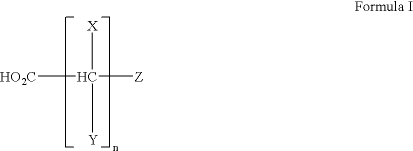
wherein each X is independently H, halogen, OH, SH, oxo, (C₁—C₈)alkyl group;
each Y is independently H, (C₁—C₈)alkyl group,
Z is H, OH, SH, COOH, or (C₁—C₈)alkyl group;
n is an integer between 1 and 10, inclusive;
and salts thereof; and
wherein said 2-oxopentanoic acid is in a volatilised state.

5. The method according to claim 1, wherein said insect is a mosquito.

6. The method according to claim 5, wherein the insect is of the genus Anopheles.

7. The method according to claim 4, wherein said insect is a mosquito.

8. The method of claim 7, wherein the insect is of the genus Anopheles.

9. The method according to claim 6, wherein said insect is Anopheles gamblae.

10. The method according to claim 8, wherein said insect is Anopheles gamblae.

11. The method according to claim 1, wherein said compound is volatilised by heating said compound.

12. The method according to claim 4, wherein said compound is volatilised by heating said compound.

13. The method according to claim 1, wherein said compound is volatilised by spraying said compound.

14. The method according to claim 4, wherein said compound is volatilised by spraying said compound.

15. The method according to claim 1, wherein said compound is contained in or on an insect trapping device.

16. The method according to claim 4, wherein said compound is contained in or on an insect trapping device.

17. The method according to claim 1, wherein said trapping device is a container trap.

18. The method according to claim 4, wherein said trapping device is a container trap.

19. A method of attracting an insect comprising using isolated 2-oxopentanoic acid; and wherein said insect is of the genus Anopheles.

20. The method of claim 19, further comprising using 2-oxopentanoic acid in combination with carbon dioxide.

21. The method of claim 19, further comprising using 2-oxopentanoic acid in combination with lactic acid.

22. A method of attracting an insect comprising using 2-oxopentanoic acid but wherein said 2-oxopentanoic acid is not used in combination with a compound as shown as formula I: 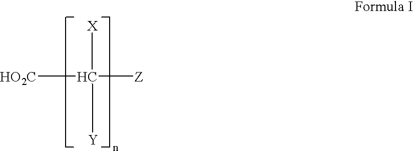
wherein each X is independently H, halogen, OH, SH, oxo, (C₁—C₈)alkyl group;
each Y is independently H, (C₁—C₈)alkyl group,
Z is H, OH, SH, COOH, or (C₁—C₈)alkyl group;
n is an integer between 1 and 10, inclusive;
and salts thereof; and
wherein said insect is of the genus Anopheles.

23. The method according to claim 19, wherein said insect is Anopheles gambiae.

24. The method according to claim 22, wherein said insect is Anopheles gambiae.

25. The method according to claim 19, wherein said compound is in a volatilised state.

26. The method according to claim 22, wherein said compound is in a volatilised state.

27. The method according to claim 25, wherein said compound is volatilised by heating said compound.

28. The method according to claim 26, wherein said compound is volatilised by heating said compound.

29. The method according to claim 25, wherein said compound is volatilised by spraying said compound.

30. The method according to claim 26, wherein said compound is volatilised by spraying said compound.

31. The method according to claim 19, wherein said compound is contained in or on an insect trapping device.

32. The method according to claim 22, wherein said compound is contained in or on an insect trapping device.

33. The method according to claim 31 wherein said trapping device is a container trap.

34. The method according to claim 32 wherein said trapping device is a container trap.

35. A method for using a compound of the Formula I:
R—C(O)—X—COOH (I)
wherein X is an optional linker group;
wherein R is a suitable hydrocarbyl group; and in an assay to screen for agents that mask or reduce the effectiveness of the compound as an insect attractant, when said compound is present on an animal surface.
